(19) United States
(12) Patent Application Publication
(10) Pub. No.: US 2007/0027691 A1
(43) Pub. Date: Feb. 1, 2007

(54) Spatialized audio enhanced text communication and methods

(76) Inventors: David S. Brenner, Mundelein, IL (US); Martin D. Wilde, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 11/194,323

(22) Filed: Aug. 1, 2005

(51) Int. Cl. G10L 13/08

(52) U.S. Cl. 704/260

(57) ABSTRACT

A text communication device (300), and corresponding methods, that receives textual information associated with one or more an attributes, for example, a source or topic attribute, the device converts the textual information to an audio signal, produces sound based on the audio signal, and spatializes the sound based on the one or more attributes with which the textual information is associated.

### FIELD OF THE DISCLOSURE

The present disclosure relates generally to text communications, and more particularly to the reception of text data by a text communication device, for example, a cellular telephone, and the conversion of the text to audio signals, which may be presented to the user of the text communication device.

### BACKGROUND OF THE DISCLOSURE

Text communication devices enable users to exchange textual messages. Textual messages among two or more users relating to a particular context or topic constitute a thread. Users often participate in textual message exchanges pertaining to multiple threads at the same time. A user participating in multiple threads needs to distinguish between the context of each of the threads. With an increase in the number of simultaneous textual message exchanges, the user has to distinguish between an increasing number of threads, along with their associated contexts. Various known methods attempt to reduce the cognitive load on users participating in multiple simultaneous communication sessions. In one known method, color schemes are used to distinguish between different communication thread, wherein each thread has a distinct color scheme to differentiate it from the other threads.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary network architecture supporting an exchange of textual information among multiple users.

FIG. 2 illustrates exemplary textual information having multiple source identifying attributes.

FIG. 3 is an exemplary text communication device.

FIG. 4 is an exemplary text-to-audio converter.

FIG. 5 is an exemplary process flow diagram.

Those of ordinary skill in the art will appreciate that elements in the figures are illustrated for simplicity and clarity and have not necessarily been drawn to scale.

### DETAILED DESCRIPTION

The present disclosure pertains generally to the exchange of textual messages between two or more participants, for example, over a communication network. Each textual message is generally associated with a source or context. For example, a context may relate to a particular topic on which textual messages are exchanged.

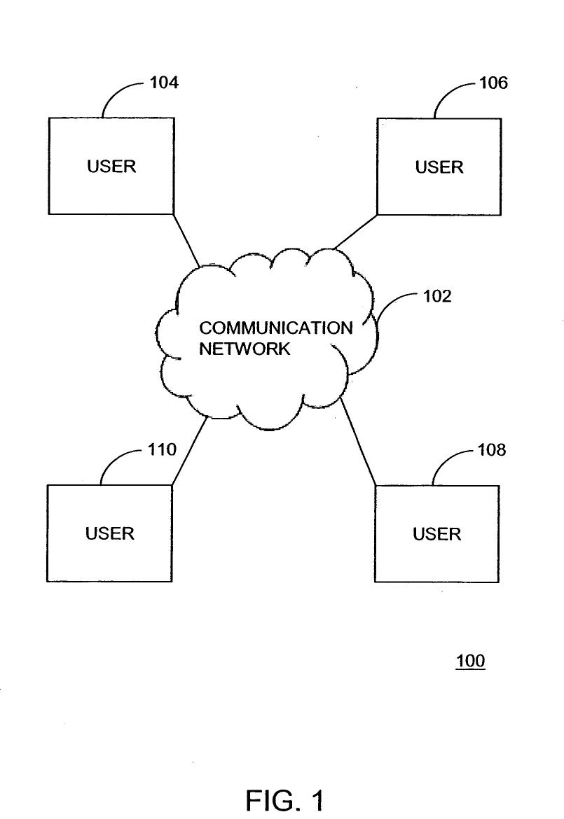

FIG. 1 is an illustrative network architecture 100 that supports the exchange of textual information among multiple users. The network architecture 100 includes a communication network 102 and users 104, 106, 108 and 110. Exemplary communication networks include wireless networks, for example, cellular communication networks, and wire-line networks, either of which may be proprietary or non-proprietary networks like the Internet and combinations thereof. The users 104, 106, 108 and 110 may exchange textual information among themselves and others in other networks. The users 104, 106, 108 and 110 can be live users, who exchange textual information with one another. For the sake of simplicity, only users 104, 106, 108 and 110 are shown in FIG. 1. In general, other users in other networks may also participate in the exchange textual information.

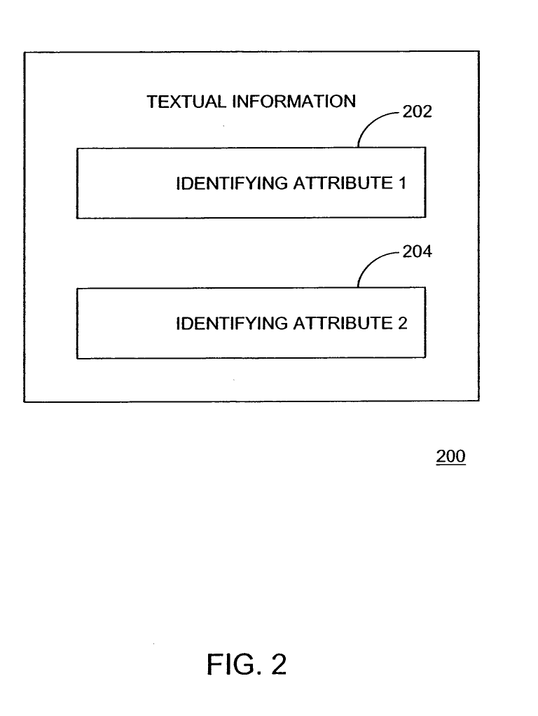

Any user of the communication network can generate and send textual information to another user or group of users in the communication network. The textual information may be in the form of a message, for example, an SMS message, an EMS, or an MMS message. Generally the text information has associated therewith at least one attribute. FIG. 2 illustrates textual information 200 with multiple identifying attributes 202 and 204. Exemplary identifying attributes include a user name in a chat session, a web address, an email address, a file name, a contact number, a topic or some other indicia by which the messages may be distinguished or grouped. In some embodiments, the attribute is encoded. Thus in FIG. 2, one attribute may uniquely identify a source of the textual information and another attribute may identify a topic with which the information is associated. Alternatively, the message may be identified by one attribute or the other. In other embodiments, the message may be identified by other attributes. The textual information is generally communicated to one or more users of the communication network with a text communication device.

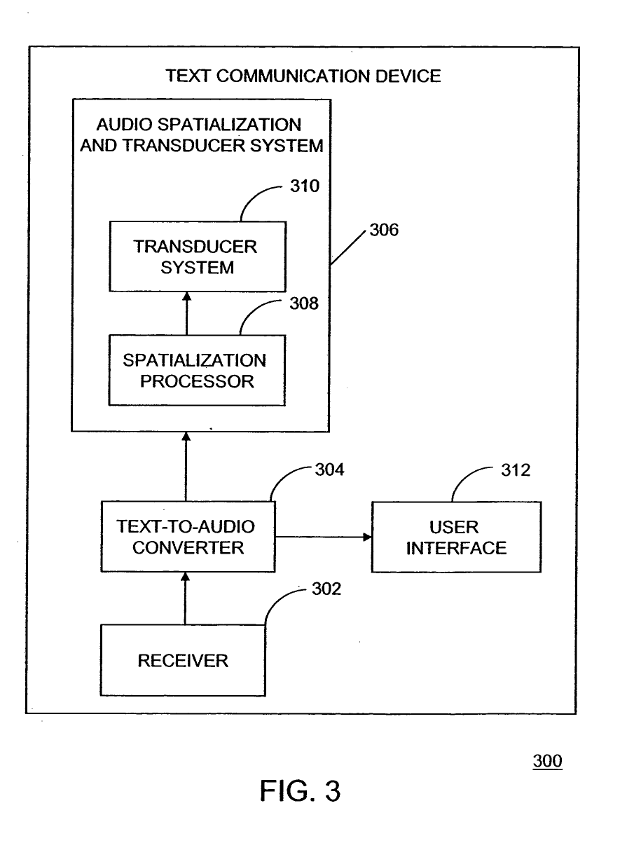

FIG. 3 is an illustrative text communication device 300. Exemplary text communication devices include pagers, mobile phones, personal digital assistants (PDAs), computer terminals, wirelessly enabled notebooks, and other wireless and wire-line communication devices. The illustrative text communication device 300 includes a receiver 302, a text-to-audio converter 304, an audio spatialization and transducer system 306, and a user interface 312. The receiver 302 receives the textual information from one or more sources. The user can receive the textual information during a chat session, an instant messaging session, or from a Really Simple Syndication (RSS) feed, email, or a file on a storage device such as a hard disk, among other sources with which the device 300 communicates.

In some embodiments, the textual information is received from the RSS feed or several RSS feeds. The RSS feeds enable the sharing of content between different websites. An exemplary RSS feed is an Extensible Markup Language (XML) file. The XML file includes a concise description of the updated web content, along with a link to its complete version. Each RSS feed is associated with a specific web address, which uniquely identifies the source of the textual information originating from that web address. In another embodiment, the textual information is received from an email account or a group of email accounts wherein each email account has a distinct identifying address, which is used to uniquely identify the source of the textual information.

In another embodiment, the textual information is received from text files kept on the storage device. In such a case, each text file includes the textual information pertaining to a particular thread, or topic or from a particular source. Examples of the text files include television show transcripts, movie transcripts, chat or instant messaging logs, and the like. The source or topic with which the textual information is associated is uniquely identified by one or more corresponding attributes, as discussed above.

In another embodiment, the textual information is received from multiple sources on a contact list. The contact list is present on the text communication device, for example, device 300 in FIG. 3. In an exemplary embodiment, the source of the textual information is uniquely identified by the contact number of the user who has transmitted the textual information.

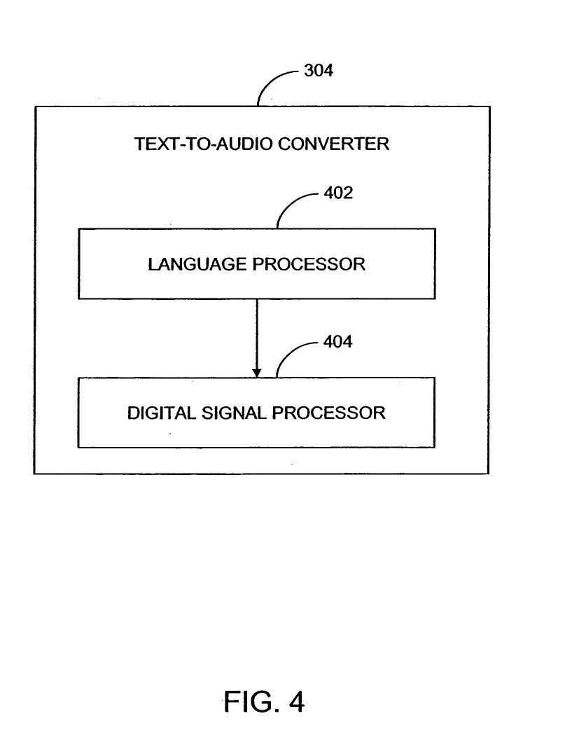

Referring to FIG. 3, the receiver 302 provides the textual information to the text-to-audio converter 304. The text-to-audio converter 304 converts the textual information to an audio signal, based on the attribute, for example, the source, associated with the textual information. Further, the text-to-audio converter 304 is coupled to the user interface 312. The text-to-audio converter 304 is explained below in conjunction with FIG. 4. In some embodiments, the received textual information is also presented to the user of the text communication device via the user interface 312.

In FIG. 3, the audio signal from the text-to-audio converter 304 is provided to the audio spatialization and transducer system 306. In one embodiment, the audio spatialization and transducer system is a multi-channel system, for example, a stereo system, capable of producing spatially located sounds from the audio signal based on the source of the textual information. The audio spatialization and transducer system 306 comprises a spatialization processor 308 and a transducer system 310. The spatialization processor 308 assigns a spatial location to the audio signal, based on the source or other classification of the textual information. For example, an audio signal generated from the textual information sent by the user 106 can be assigned a spatial location. The spatial location is closest to the user receiving the textual information. The transducer system 310 receives the audio signal from the spatialization processor 308. The transducer system 310 produces sound from the audio signal.

In some embodiments, spatialization of sounds is carried out by locating each sound in corresponding spatially separated locations. Generally, each sound is spatially located based on its one or more attributes. For the case where there is a single sound, the single sound may be located in a particular spatial location. Where there are many sounds associated with corresponding attributes, each sound may be spatially located in corresponding locations about the user.

In one embodiment, the spatial locations are determined, for example, by dividing a spherical space of 360 degrees, surrounding the user between the different sounds. For example, when the user receives the textual information from three sources, the textual information from each of the sources is converted to sounds, and the sounds are assigned spatial locations about the user. The sources are identified by the corresponding source identifying attributes. The sounds may also be spatially located based on a topic attribute or on multiple attributes. In a particular case, each spatial location about the user can be separated from the other spatial locations by 120 degrees. More generally, the angular separation between sounds is not necessarily the same. For example, sounds from different sources or associated with different topics may be spaced irregularly. In another embodiment, sounds associated with a particular topic from different sources are spatially located in one area, and sounds associated with a different topic from different sources are spatially located in a different area.

FIG. 4 is an exemplary text-to-audio converter 304, which processes the textual information and converts it to the audio signal. The text-to-audio converter 304 comprises a language processor 402 and a digital signal processor 404. The language processor 402 produces a phonetic transcription of the textual information, as well as prosodic information such as the rhythm, tone and pitch corresponding to the phonetic transcription. The digital signal processor 404 uses the prosodic information to transform the phonetic transcription to the audio signal.

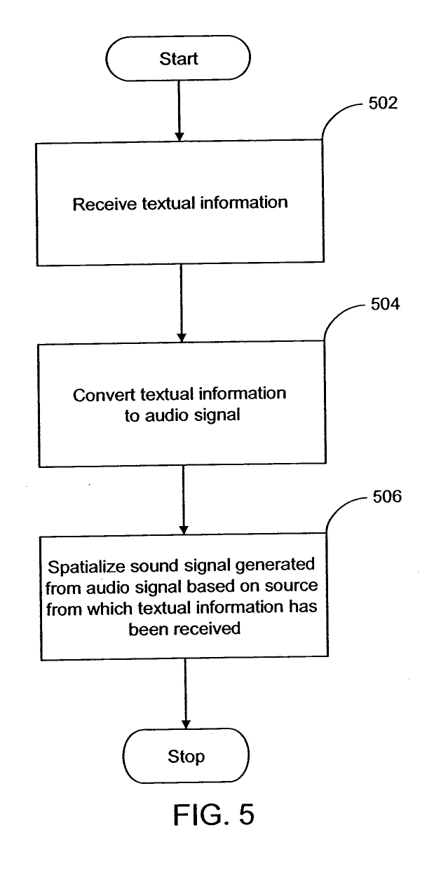

FIG. 5 is an exemplary process flow diagram illustrating a method for the reception of the textual information by a text communication device. At step 502, the user receives the textual information from a user or a group of users in the communication network, for example, the network 102 in FIG. 1. In FIG. 5, at step 504, the textual information is converted into an audio signal. At step 506, the audio signal is converted into sound by one or more transducers. The sound is then assigned a spatial location based on the attribute, for example, depending on the source from which the textual information was received or based on the classification of the textual information from which the sound was generated.

The embodiments described above have the advantage that they allow the user to effectively distinguish between textual information exchanged with different users in the communication network. Further, the various threads the user is participating in are spatially segregated. This reduces the cognitive load on the user.

It will be appreciated that embodiments of the disclosure described herein may be comprised of one or more conventional processors and unique stored program instructions that control the one or more processors to implement, in conjunction with certain non-processor circuits, some, most, or all of the functions of reception of textual data by a text communication device, and the conversion of the textual data to an audio signal, described herein. The non-processor circuits may include, but are not limited to, a radio receiver, a radio transmitter, signal drivers, clock circuits, power source circuits, and user input devices. As such, these functions may be interpreted as steps of a method to perform reception of the textual data by a text communication device, and the conversion of the textual data to an audio signal. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the invention, which is to be limited not by the exemplary embodiments but by the appended claims.

What is claimed is:

1. A method in a text communication device, the method comprising:
receiving textual information associated with a source;
converting the textual information to an audio signal;
producing sound based on the audio signal; and
spatializing the sound based on the source with which the textual information is associated.

2. The method of claim 1,
receiving textual information associated with at least two different sources;
converting the textual information to corresponding audio signals based on the source with which the textual information is associated;
producing sounds based on the corresponding audio signals; and
spatially locating each sound based upon the source with which the corresponding textual information is associated.

3. The method of claim 2, receiving textual information associated with at least two different sources includes receiving textual information from multiple users in one of a chat or instant messaging session.

4. The method of claim 2, receiving textual information associated with at least two different sources includes receiving textual information from multiple really simple syndication feeds.

5. The method of claim 2, receiving textual information associated with at least two different sources includes receiving email associated with separate email accounts.

6. The method of claim 2, receiving textual information associated with at least two different sources includes receiving textual information from multiple senders named on a contact list of the text communication device; and
spatially locating each sound based upon corresponding names in the contact list.

7. The method of claim 1, spatially locating the sound includes locating the sound in a particular spatial location.

8. The method of claim 1,
receiving textual information includes receiving textual information associated with at least two different sources identified by corresponding source attributes;
converting the textual information to corresponding audio signals based on the source attributes;
producing sounds based on the corresponding audio signals; and
spatially locating each sound based upon the source with which the corresponding textual information is associated.

9. A method in a text communication device, the method comprising:
converting textual information associated with at least one attribute to an audio signal;
producing a sound based on the audio signal; and
spatially locating the sound based on the at least one attribute.

10. The method of claim 9, spatially locating the sound includes locating the sound in particular spatial location.

11. The method of claim 9, converting textual information associated with the at least one attribute to the audio signal includes converting textual information received during one of a chat or instant messaging session.

12. The method of claim 9, converting textual information associated with the at least one attribute to the audio signal includes converting textual information received from a really simple syndication feed.

13. The method of claim 9, converting textual information associated with the at least one attribute to the audio signal includes converting textual information received in an email associated with an email account.

14. The method of claim 9, converting textual information associated with the at least one attribute to the audio signal includes converting textual information received from a sender named on a contact list stored on the text communication device.

15. An apparatus for receiving textual information, the apparatus comprising:
a receiver;
a text-to-audio converter communicably coupled to the receiver;
the text-to-audio converter capable of converting textual information received by the receiver to an audio signal;
an audio spatialization and transducer system communicably coupled to the text-to-audio converter; and
the audio spatialization and transducer system producing spatially located sound from the audio signal based upon an attribute of textual information.

16. The apparatus of claim 15, includes a user interface for presenting textual information to a user of the text communication device.

17. The apparatus of claim 15, the audio spatialization and transducer system includes a spatialization processor having an output to a transducer system.

18. The apparatus of claim 17,
the text-to-audio converter for converting textual information received from multiple sources by the receiver to corresponding audio signals; and
the audio spatialization and transducer system for producing spatially separated sounds from corresponding audio signals based upon source attributes of the textual information.

19. The apparatus of claim 15, the text-to-audio converter includes:
a language processor for producing a phonetic transcription of the textual information; and
a digital signal processor for transforming a phonetic transcription of the textual information into an audio signal.
